(19) United States
(12) Patent Application Publication
(10) Pub. No.: US 2025/0192309 A1
(43) Pub. Date: Jun. 12, 2025

(54) INTERLOCKING CELL STACK END PLATES FOR MULTI-TIERED TRACTION BATTERY PACKS

(71) Applicant: FORD GLOBAL TECHNOLOGIES, LLC, Dearborn, MI (US)

(72) Inventors: Derek Timothy Taylor, Waterford, MI (US); Nicholas Braeseker, Novi, MI (US)

(21) Appl. No.: 18/936,101

(22) Filed: Nov. 4, 2024

Related U.S. Application Data
(60) Provisional application No. 63/607,888, filed on Dec. 8, 2023.

(51) Int. Cl. H01M 50/244; H01M 50/249; H01M 50/262

(52) U.S. Cl. CPC H01M 50/244; H01M 50/249; H01M 50/262; H01M 2220/20

(57) ABSTRACT

Traction battery packs are provided that include a multi-tiered battery system. An exemplary battery system may include a plurality of cell stacks, with each cell stack including an end plate. Each end plate may include features designed to allow it to interlock/interconnect/mesh/nest with the end plates of one or more adjacent cell stacks within the battery system to provide a space efficient design. Moreover, the end plates of upper and lower tiered cell stacks may cooperate to establish a mid-plate assembly of the battery system.

### CROSS-REFERENCE TO RELATED APPLICATIONS

This disclosure claims priority to U.S. Provisional Application No. 63/607,888, which was filed on Dec. 8, 2023 and is incorporated herein by reference in its entirety.

### TECHNICAL FIELD

This disclosure relates generally to traction battery packs, and more particularly to interlocking cell stack end plates for use within multi-tiered traction battery packs.

### BACKGROUND

Electrified vehicles include a traction battery pack for powering electric machines and other electrical loads of the vehicle. The traction battery pack includes a plurality of battery cells and various other battery internal components that support electric vehicle propulsion. Some traction battery packs include cell stacks arranged in multiple tiers.

### SUMMARY

A traction battery pack according to an exemplary aspect of the present disclosure includes, among other things, a first cell stack including a first end plate, and a second cell stack including a second end plate. The second end plate is inverted relative to the first end plate so that the first end plate and the second end plate are configured to nest together.

In a further non-limiting embodiment of the foregoing traction battery pack, a third cell stack includes a third end plate, and a fourth cell stack includes a fourth end plate.

In a further non-limiting embodiment of either of the foregoing traction battery packs, the fourth end plate is inverted relative to the third end plate so that the third end plate and the fourth end plate are configured to nest together.

In a further non-limiting embodiment of any of the foregoing traction battery packs, the first cell stack and the second cell stack establish a lower tier of a battery system, and the third cell stack and the fourth cell stack establish an upper tier of the battery system.

In a further non-limiting embodiment of any of the foregoing traction battery packs, the second end plate is mounted to the first end plate, the third end plate is mounted to the second end plate, and the fourth end plate is mounted to the third end plate.

In a further non-limiting embodiment of any of the foregoing traction battery packs, the first end plate is mounted to an enclosure tray of an enclosure assembly of the traction battery pack.

In a further non-limiting embodiment of any of the foregoing traction battery packs, the first end plate includes a first mounting tab that is accommodated within a first mounting slot of the second end plate.

In a further non-limiting embodiment of any of the foregoing traction battery packs, the second end plate includes a second mounting tab that is accommodated within a second mounting slot of the first end plate.

In a further non-limiting embodiment of any of the foregoing traction battery packs, a first fastener is received through the second mounting tab and into the first end plate.

In a further non-limiting embodiment of any of the foregoing traction battery packs, a second fastener is received through the first end plate to mount the first end plate to the first cell stack.

In a further non-limiting embodiment of any of the foregoing traction battery packs, the first end plate is mounted to an enclosure tray of an enclosure assembly of the traction battery pack.

In a further non-limiting embodiment of any of the foregoing traction battery packs, the second end plate is mounted to the first end plate.

A traction battery pack according to another exemplary aspect of the present disclosure includes, among other things, a battery system including a first cell stack having a first end plate, a second cell stack having a second end plate, a third cell stack having a third end plate, and a fourth cell stack having a fourth end plate. The first end plate, the second end plate, the third end plate, and the fourth end plate cooperate to establish a mid-plate assembly of the battery system.

In a further non-limiting embodiment of the foregoing traction battery pack, the first cell stack and the second cell stack establish a lower tier of the battery system, and the third cell stack and the fourth cell stack establish an upper tier of the battery system.

In a further non-limiting embodiment of either of the foregoing traction battery packs, the first end plate is mounted to an enclosure tray of an enclosure assembly of the traction battery pack.

In a further non-limiting embodiment of any of the foregoing traction battery packs, the second end plate is mounted to the first end plate.

In a further non-limiting embodiment of any of the foregoing traction battery packs, the third end plate is mounted to the second end plate.

In a further non-limiting embodiment of any of the foregoing traction battery packs, the fourth end plate is mounted to the third end plate.

In a further non-limiting embodiment of any of the foregoing traction battery packs, the first end plate includes a first mounting tab that is accommodated within a first mounting slot of the second end plate, and the second end plate includes a second mounting tab that is accommodated within a second mounting slot of the first end plate.

A method for assembling a battery system of a traction battery pack according to another exemplary aspect of the present disclosure includes, among other things, mounting a first end plate of a first cell stack of the battery system to an enclosure tray of the traction battery pack, mounting a second end plate of a second cell stack of the battery system to the first end plate of the first cell stack, mounting a third end plate of a third cell stack of the battery system to the second end plate of the second cell stack, and mounting a fourth end plate of a fourth cell stack of the battery system to the third end plate of the third cell stack.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 is a perspective view of a traction battery pack for an electrified vehicle.

FIG. 3 illustrates a battery system of the traction battery pack of FIG. 2.

FIG. 4 illustrates an exemplary end plate of a cell stack of the battery system of FIG. 3.

FIG. 5 is an end view of the end plate of FIG. 4.

FIG. 6 is a first cross-sectional view of the battery system of FIG. 3.

FIG. 7 is a second cross-sectional view of the battery system of FIG. 3.

FIG. 8 schematically illustrates an assembly method for assembling a multi-tiered battery system of a traction battery pack.

### DETAILED DESCRIPTION

This disclosure details traction battery packs that include a multi-tiered battery system. An exemplary battery system may include a plurality of cell stacks, with each cell stack including an end plate. Each end plate may include features designed to allow it to interlock/interconnect/mesh/nest with the end plates of one or more adjacent cell stacks within the battery system to provide a space efficient design. Moreover, the end plates of upper and lower tiered cell stacks may cooperate to establish a mid-plate assembly of the battery system. These and other features are discussed in greater detail in the following paragraphs of this detailed description.

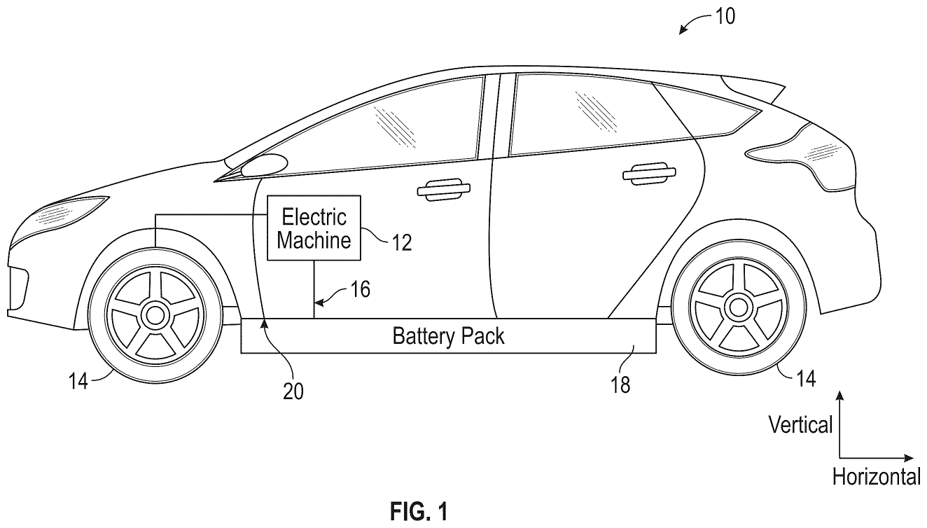

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component, assembly, or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

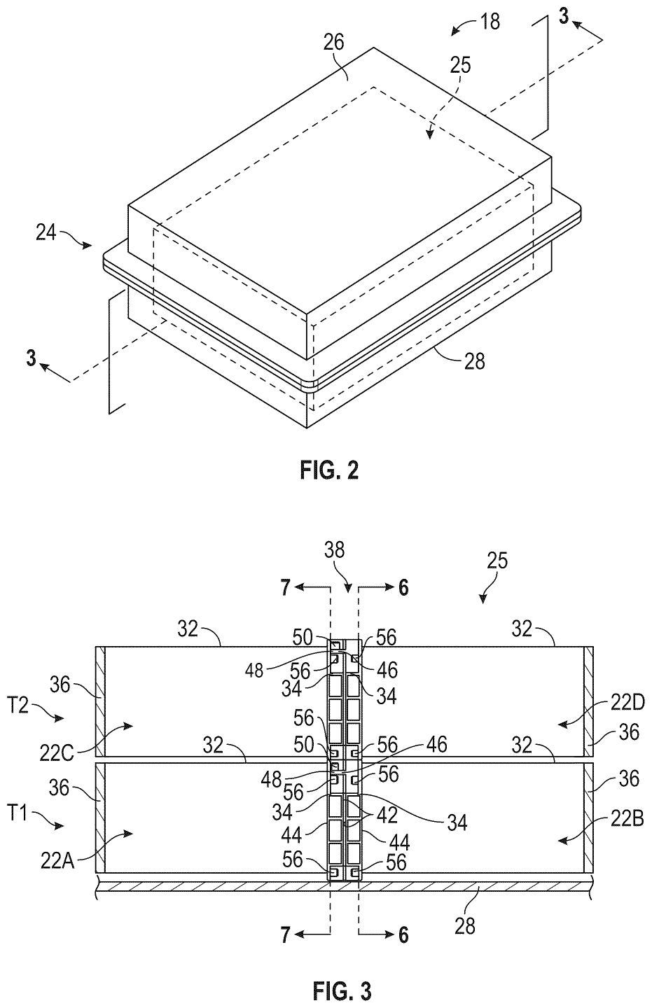

FIGS. 2 and 3 illustrate additional details associated with the traction battery pack 18 of the electrified vehicle 10 of FIG. 1. The traction battery pack 18 may include a battery system 25 housed within an interior area of an enclosure assembly 24. The enclosure assembly 24 of the traction battery pack 18 may include an enclosure cover 26 and an enclosure tray 28. The enclosure cover 26 may be secured (e.g., bolted, welded, adhered, etc.) to the enclosure tray 28 to provide the interior area for housing the battery system 25 and other battery internal components of the traction battery pack 18.

As best shown in FIG. 3, the battery system 25 may include a first or lower tier T1 and a second or upper tier T2 that is vertically above the lower tier T1. Vertical and horizontal, for purposes of this disclosure, are with reference to ground and a general orientation of traction battery pack 18 when installed on the electrified vehicle 10 of FIG. 1. The lower tier T1 may include a first cell stack 22A and a second cell stack 22B of the battery system 25, and the upper tier T2 may include a third cell stack 22C and a fourth cell stack 22D of the battery system 25. The battery system 25 is considered to be a multi-tiered battery system because it includes cell stacks on more than one tier.

Although the lower tier T1 and the upper tier T2 are each illustrated as including two cell stacks, each tier could include greater than two cell stacks. Further, although two tiers are shown in the exemplary battery system 25, other examples could include more than two tiers of cell stacks.

Each cell stack 22A-22D may include a plurality of battery cells 32 (shown schematically and stacked into page in FIG. 3). The total number of battery cells 32 provided within each of the cell stacks 22A-22D is not intended to limit this disclosure. In an embodiment, the battery cells 32 are lithium-ion prismatic cells. However, battery cells having other geometries (cylindrical, pouch, etc.) and/or chemistries (nickel-metal hydride, lead-acid, etc.) could alternatively be utilized within the scope of this disclosure.

The battery cells 32 of each cell stack 22A-22D may be stacked together and arranged between an end plate 34 and an opposing end plate 36. One of the end plates 34 may be arranged at an inboard side of each cell stack 22A-22D, and one of the opposing end plates 36 may be arranged at an outboard side of each cell stack 22A-22D. Within the lower tier T1, the end plate 34 of the first cell stack 22A may face toward and interface with the end plate 34 of the second cell stack 22B, and within the upper tier T2, the end plate 34 of the third cell stack 22C may face toward and interface with the end plate 34 of the fourth cell stack 22D. Moreover, as further discussed below, the end plates 34 of the upper tier T2 may interrace with one or more of the end plates 34 of the lower tier T1.

In an embodiment, the end plates 34 of the first cell stack 22A and the second cell stack 22B are inverted relative to one another, and the end plates 34 of the third cell stack 22A and the fourth cell stack 22D are inverted relative to one another. Stated another way, the end plates 34 of horizontally adjacent cell stacks 22 of the battery system 25 may be rotated by 180 degrees relative to one another. As further discussed below, the inverted relationship between horizontally adjacent end plates 34 may provide a more space efficient design for the multi-tiered battery system 25.

The end plates 34 of the first cell stack 22A, the second cell stack 22B, the third cell stack 22C, and the fourth cell stack 22D may be connected together to establish a mid-plate assembly 38 of the battery system 25. The mid-plate assembly 38 may be secured (e.g., mechanically fastened) directly to the enclosure tray 28 for structurally integrating the battery system 25 and the enclosure assembly 24 of the traction battery pack 18.

The opposing end plates 36 may embody a different design (e.g., in terms of size, shape, overall configuration, etc.) compared to the end plates 34. The opposing end plates 36 generally do not interface with one another in an exemplary implementation of the battery system 25. The opposing end plates 36 may be secured to the cell stacks 22A-22D using any fastening technique (e.g., mechanical fasteners, adhesive, etc.).

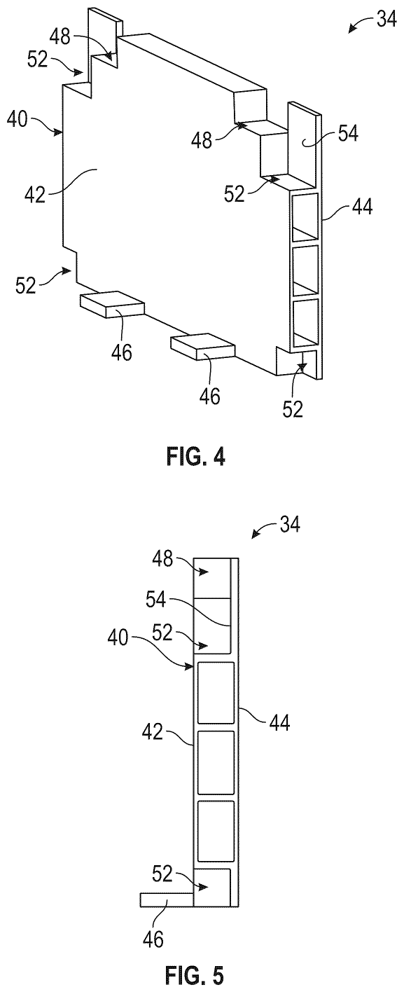

Referring now to FIGS. 3-7, each end plate 34 may include an irregular-shaped body 40 that includes a first side 42 and a second side 44. In an assembled state of the battery system 25, the first side 42 of each end plate 34 faces toward the first side 42 of the end plate 34 of a horizontally adjacent cell stack 22, and the second side 44 of each end plate 34 faces toward its respective cell stack 22.

The end plate 34 of each cell stack 22A-22D may include features designed to allow it to interlock/interconnect/mesh/nest with the end plates 34 of one or more adjacent cell stacks 22A-22D within the battery system 25. For example, each end plate 34 may include a combination of mounting tabs 46 and mounting slots 48. In an embodiment, each end plate 34 may include a pair of mounting tabs 46 and a pair of mounting slots 48. However, other configurations are contemplated within the scope of this disclosure, and thus the end plates 34 could include a greater or fewer number of mounting tabs 46 and/or mounting slots 48.

The mounting tabs 46 may protrude outwardly from the first side 42 of the irregular-shaped body 40 in a direction opposite from the second side 44. The mounting slots 48 may extend from the first side 42 to the second side 44 and are therefore formed through the irregular-shaped body 40.

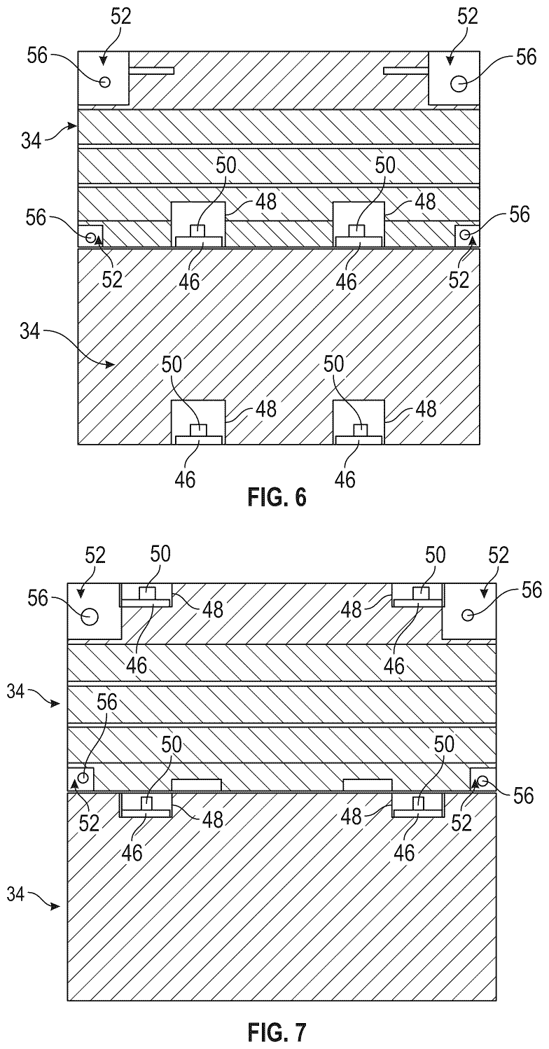

The mounting tabs 46 and mounting slots 48 cooperate to allow each end plate 34 to mesh with a horizontally adjacent and inverted end plate 34 of the battery system 25. For example, the mounting tabs 46 of the first cell stack 22A may be received within the mounting slots 48 of the second cell stack 22B, and the mounting tabs 46 of the third cell stack 22C may be received within the mounting slots 48 of the fourth cell stack 22D (see FIG. 6). Likewise, the mounting tabs 46 of the second cell stack 22B may be received within the mounting slots 48 of the first cell stack 22A, and the mounting tabs 46 of the fourth cell stack 22D may be received within the mounting slots 48 of the third cell stack 22C (see FIG. 7). The meshed relationship between the end pates 34 provides a space efficient design.

A first fastener 50 (e.g., a bolt or screw) may be inserted through each mounting tab 46 for mounting the end plate 34 to an adjacent structure (e.g., to another end plate 34 or to the enclosure tray 28). For example, the first fasteners 50 may be inserted through the mounting tabs 46 for mounting (1) the end plate 34 of the first cell stack 22A to the enclosure tray 28, (2) the end plate 34 of the second cell stack 22B to the end plate 34 of the first cell stack 22A, (3) the end plate 34 of the third cell stack 22C to the end plate 34 of the second cell stack 22B, and (4) the end plate 34 of the fourth cell stack 22D to the end plate 34 of the third cell stack 22C. Each first fastener 50 may be inserted vertically through the mounting tabs 46 for mounting the various structures together.

A pocket 52 may be provided near each corner of the irregular-shaped body 40. The pockets 52 may extend from the first side 42 to an inner surface 54 of the second side 44. The inner surfaces 54 may provide mounting surfaces for mounting each end plate 34 to its respective cell stack 22. For example, a second fastener 56 (e.g., a bolt or screw) may be inserted horizontally through each pocket 52 and then through the second side 44 to mount the end plate 34 to its respective cell stack 22. The pockets 52 are located laterally outward of the mounting slots 48, and therefore the first fasteners 50 and the second fasteners 56 do not interfere with one another during their insertion.

Each end plate 34 may be a cast or extruded part made from a relatively rigid material, such as a metallic material, for example. However, the manufacturing technique utilized and the material make-up of the first end plates 34 are not intended to limit this disclosure.

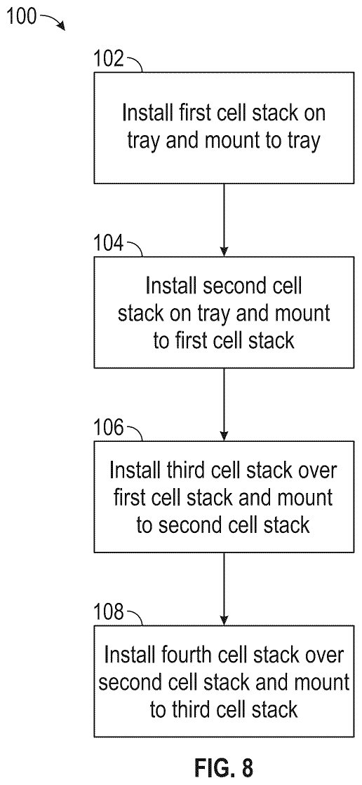

FIG. 8, with continued reference to FIGS. 1-7, schematically illustrates an assembly method 100 for assembling the multi-tiered battery system 25 of the traction battery pack 18. The assembly method 100 may include a greater or fewer number of steps than those recited below. Notably, the assembly method 100 assumes that the end plates 34 have already been secured to their respective cell stacks 22 by the second fasteners 56.

First, at block 102, the first cell stack 22A may be installed on and mounted to the enclosure tray 28. One or more of the first fasteners 50 may be inserted through each mounting tab 46 of the end plate 34 of the first cell stack 22A for mounting the first cell stack 22A to the enclosure tray 28.

Next, at block 104, the second cell stack 22B may be installed on the enclosure tray 28 and then be mounted to the first cell stack 22A. Due to the inverted relationship between the end plates 34 of the first and second cell stacks 22A, 22B, the mounting tabs 46 of the end plate 34 of the first cell stack 22A may be accommodated in nesting fashion within the mounting slots 48 of the end plate 34 of the second cell stack 22B and vice versa. One or more of the first fasteners 50 may be inserted through each mounting tab 46 of the end plate 34 of the second cell stack 22B and extend into the end plate 34 of the first cell stack 22A for mounting the second cell stack 22B to the first cell stack 22A. Once mounted in the manner shown in blocks 102 and 104, the first and second cell stacks 22A, 22B establish the lower tier T1 of the battery system 25.

Next, at block 106, the third cell stack 22C may be installed over top of the first cell stack 22A and then be mounted to the second cell stack 22B. One or more first fasteners 50 may be inserted through each mounting tab 46 of the end plate 34 of the third cell stack 22B and extend into the end plate 34 of the second cell stack 22A for mounting the third cell stack 22C to the second cell stack 22B.

Next, at block 108, the fourth cell stack 22D may be installed over top of the second cell stack 22B and then be mounted to the third cell stack 22C. Due to the inverted relationship between the end plates 34 of the third and fourth cell stacks 22C, 22D, the mounting tabs 46 of the end plate 34 of the third cell stack 22C may be accommodated in nesting fashion within the mounting slots 48 of the end plate 34 of the fourth cell stack 22D and vice versa. One or more of the first fasteners 50 may be inserted through each mounting tab 46 of the end plate 34 of the fourth cell stack 22D and extend into the end plate 34 of the third cell stack 22C for mounting the fourth cell stack 22D to the third cell stack 22C.

Once mounted in the manner shown in blocks 106 and 108, the third and fourth cell stacks 22C, 22D establish the upper tier T2 of the battery system 25. Moreover, the interlocked end plates 34 of the first, second, third, and fourth cell stacks 22A-22D establish the mid-plate assembly 38 of the battery system 25 and thereby provide the space efficient design.

The exemplary traction battery packs of this disclosure include a multi-tiered battery system having a plurality of cell stacks. The cell stacks include nestable end plates that establish a mid-plate assembly for providing a more space efficient design. The nestable end plates may be secured together by fasteners while allowing for a vertical fastener rundown methodology that eliminates interference with additional fasteners of the system.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
a first cell stack including a first end plate; and
a second cell stack including a second end plate;
wherein the second end plate is inverted relative to the first end plate so that the first end plate and the second end plate are configured to nest together.

2. The traction battery pack as recited in claim 1, comprising:
a third cell stack including a third end plate; and
a fourth cell stack including a fourth end plate.

3. The traction battery pack as recited in claim 2, wherein the fourth end plate is inverted relative to the third end plate so that the third end plate and the fourth end plate are configured to nest together.

4. The traction battery pack as recited in claim 2, wherein the first cell stack and the second cell stack establish a lower tier of a battery system, and the third cell stack and the fourth cell stack establish an upper tier of the battery system.

5. The traction battery pack as recited in claim 2, wherein the second end plate is mounted to the first end plate, the third end plate is mounted to the second end plate, and the fourth end plate is mounted to the third end plate.

6. The traction battery pack as recited in claim 5, wherein the first end plate is mounted to an enclosure tray of an enclosure assembly of the traction battery pack.

7. The traction battery pack as recited in claim 1, wherein the first end plate includes a first mounting tab that is accommodated within a first mounting slot of the second end plate.

8. The traction battery pack as recited in claim 7, wherein the second end plate includes a second mounting tab that is accommodated within a second mounting slot of the first end plate.

9. The traction battery pack as recited in claim 8, comprising a first fastener received through the second mounting tab and into the first end plate.

10. The traction battery pack as recited in claim 9, wherein a second fastener is received through the first end plate to mount the first end plate to the first cell stack.

11. The traction battery pack as recited in claim 1, wherein the first end plate is mounted to an enclosure tray of an enclosure assembly of the traction battery pack.

12. The traction battery pack as recited in claim 11, wherein the second end plate is mounted to the first end plate.

13. A traction battery pack, comprising:
a battery system including a first cell stack having a first end plate, a second cell stack having a second end plate, a third cell stack having a third end plate, and a fourth cell stack having a fourth end plate,
wherein the first end plate, the second end plate, the third end plate, and the fourth end plate cooperate to establish a mid-plate assembly of the battery system.

14. The traction battery pack as recited in claim 13, wherein the first cell stack and the second cell stack establish a lower tier of the battery system, and the third cell stack and the fourth cell stack establish an upper tier of the battery system.

15. The traction battery pack as recited in claim 13, wherein the first end plate is mounted to an enclosure tray of an enclosure assembly of the traction battery pack.

16. The traction battery pack as recited in claim 15, wherein the second end plate is mounted to the first end plate.

17. The traction battery pack as recited in claim 16, wherein the third end plate is mounted to the second end plate.

18. The traction battery pack as recited in claim 17, wherein the fourth end plate is mounted to the third end plate.

19. The traction battery pack as recited in claim 13, wherein the first end plate includes a first mounting tab that is accommodated within a first mounting slot of the second end plate, and the second end plate includes a second mounting tab that is accommodated within a second mounting slot of the first end plate.

20. A method for assembling a battery system of a traction battery pack, comprising:
mounting a first end plate of a first cell stack of the battery system to an enclosure tray of the traction battery pack;
mounting a second end plate of a second cell stack of the battery system to the first end plate of the first cell stack;
mounting a third end plate of a third cell stack of the battery system to the second end plate of the second cell stack; and
mounting a fourth end plate of a fourth cell stack of the battery system to the third end plate of the third cell stack.
